(19) United States
(12) Patent Application Publication
(10) Pub. No.: US 2016/0024959 A1
(43) Pub. Date: Jan. 28, 2016

(54) VARIABLE VANE DRIVE SYSTEM

(71) Applicant: UNITED TECHNOLOGIES CORPORATION, Hartford, CT (US)

(72) Inventors: Logan H. Do, Canton, CT (US); Richard L. Sykes, East Hartford, CT (US)

(21) Appl. No.: 14/774,899

(22) PCT Filed: Feb. 18, 2014
(86) PCT No.: PCT/US14/16849

§ 371 Date: Sep. 11, 2015

Related U.S. Application Data
(60) Provisional application No. 61/831,730, filed on Jun. 6, 2013.
(60) Provisional application No. 61/778,731, filed on Mar. 13, 2013.

(51) Int. Cl. F01D 17/14; F01D 9/04

(52) U.S. Cl. CPC F01D 17/14; F01D 9/041; F05D 2220/32; F05D 2240/129

(57) ABSTRACT

An example section of a gas turbine engine includes a plurality of variable vanes circumferentially disposed about an engine axis, a first moveable annular ring disposed on an upstream side of the variable vanes, a second movable annular ring disposed on a downstream side of the variable vanes, and a plurality of vane arms, each including a first end secured to the first annular ring and a second end secured to the second annular ring. Movement of the first and second annular rings moves the vane arms, thereby actuating the plurality of variable vanes. An example variable vane assembly includes a vane arm including a portion that engages a variable vane, a first end configured to be secured to a first movable annular ring, and a second end configured to be secured to a second movable annular ring.

Movement of the first and second annular rings moves the vane arms, thereby actuating the plurality of variable vanes. An example method of actuating a variable vane assembly includes the steps of securing a variable vane to a vane arm, the vane arm secured to a first movable annular ring at a so first end and a second movable annular ring at a second end, and moving at least one of the first and second rings to move the vane arm.

### BACKGROUND

This disclosure relates to a variable vane drive system for a gas turbine engine.

A gas turbine engine typically includes a fan section, a compressor section, a combustor section, and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

A speed reduction device such as an epicyclical gear assembly may be utilized to drive the fan section such that the fan section may rotate at a speed different and typically slower than the turbine section so as to provide a reduced part count approach for increasing the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds.

Although geared architectures utilized to drive the fan have improved propulsive efficiency, turbine engine manufacturers continue to seek further improvements to engine performance including improvements to thermal, transfer, and propulsive efficiencies.

Some areas of the engine may include variable vanes. The compressor, for example, may include multiple stages of variable vanes. In some compressor designs, the variable vanes are connected to a synchronizing ring (sync-ring) by vane arms and form a sub-kinematic system for a particular stage. The vanes are driven by the sync-rings, which rotate clockwise and counterclockwise around the compressor case to pivot the vane arms and set the vane angle that optimizes engine operability. During operation, an actuation system drives the sync-ring. The sync-ring can be elastically deflected by reaction forces generated during vane movement. Some variable vane actuation systems may also have “assembly slop” such as gaps or deflections between the sync-ring and vane arm.

### SUMMARY

A section of a gas turbine engine according to an exemplary aspect of the present disclosure includes, among other things, a plurality of variable vanes circumferentially disposed about an engine axis, a first moveable annular ring disposed on an upstream side of the variable vanes, a second movable annular ring disposed on a downstream side of the variable vanes, and a plurality of vane arms, each including a first end secured to the first annular ring and a second end secured to the second annular ring, wherein movement of the first and second annular rings moves the vane arms, thereby actuating the plurality of variable vanes.

In a further non-limiting embodiment of the foregoing engine section, movement of the first and second rings causes the vane arm to pivot about a radially extending axis.

In a further non-limiting embodiment of either of the foregoing engine sections, the engine section further comprises a bell crank configured to move at least one of the first and second rings.

In a further non-limiting embodiment of any of the foregoing engine sections, the bell crank is configured to move the first and second rings in opposite circumferential directions.

In a further non-limiting embodiment of any of the foregoing engine sections, the engine section further comprises an actuator configured to actuate the first bell crank.

In a further non-limiting embodiment of any of the foregoing engine sections, the engine section further comprises a second engine section including a second plurality of variable vanes circumferentially disposed about the engine axis, a third moveable annular ring disposed on an upstream side of the second plurality of variable vanes, a fourth movable annular ring disposed on a downstream side of the second plurality of vane arms, and a second plurality of vane arms, each including a first end secured to the first annular ring and a second end secured to the second annular ring, wherein movement of the first and second annular rings moves the second plurality of vane arms, thereby actuating the second plurality of variable vanes.

In a further non-limiting embodiment of any of the foregoing engine sections, the engine section further comprises a second bell crank configured to move at least one of the third and fourth rings.

In a further non-limiting embodiment of any of the foregoing engine sections, the engine section further comprises a second actuator configured to actuate the second bell crank.

In a further non-limiting embodiment of any of the foregoing engine sections, the first and second actuators are configured to operate independently of one another.

In a further non-limiting embodiment of any of the foregoing engine sections, the engine section further comprises a link configured to transfer forces between the first and second bell cranks.

In a further non-limiting embodiment of any of the foregoing engine sections, the actuator is configured to actuate both the first and second bell cranks.

In a further non-limiting embodiment of any of the foregoing engine sections, at least one of the first and second rings include at least one load relief slot.

In a further non-limiting embodiment of any of the foregoing engine sections, the at least one load relief slot is formed around a portion of one of the first and second rings configured to receive the vane arms.

In a further non-limiting embodiment of any of the foregoing engine sections, the engine section is a compressor section.

A variable vane assembly according to an exemplary aspect of the present disclosure includes, among other things, a vane arm including a portion that engages a variable vane, a first end configured to be secured to a first movable annular ring, and a second end configured to be secured to a second movable annular ring, wherein movement of the first and second annular rings moves the vane arms, thereby actuating the plurality of variable vanes.

In a further non-limiting embodiment of the foregoing variable vane assembly, the first end is upstream from the second end, relative to a direction of flow through the variable vane assembly.

In a further non-limiting embodiment of either of the foregoing variable vane assemblies, the portion that engages the variable vane is between the first and second ends.

A method of actuating a variable vane assembly according to an exemplary aspect of the present disclosure includes, among other things, securing a variable vane to a vane arm, the vane arm secured to a first movable annular ring at a first end and a second movable annular ring at a second end, and moving at least one of the first and second rings to move the vane arm.

In a further non-limiting embodiment of the foregoing method of actuating a variable vane assembly, the moving step is provided by a bell crank.

In a further non-limiting embodiment of either of the foregoing methods of actuating a variable vane assembly, the bell crank is actuated by an actuator.

### BRIEF DESCRIPTION OF THE DRAWINGS

FIG. 1 schematically illustrates an example gas turbine engine.

FIG. 2 illustrates an example high pressure compressor of the gas turbine engine of FIG. 1 that includes variable vanes and an independent variable vane drive system.

FIG. 3a illustrates a close-up view of some of the variable vanes of FIG. 2.

FIG. 3b illustrates a close-up view of a sync-ring for the variable vanes of FIG. 3a including a load relief slot.

FIG. 4a illustrates a cutaway view of the variable vanes of FIG. 3a.

FIG. 4b illustrates a close-up cutaway view of a portion of a fastener for the variable vanes of FIG. 4a.

FIG. 5a illustrates a vane arm of the variable vanes of FIG. 2.

FIG. 5b illustrates a close-up view of a portion of the vane arm of FIG. 5a.

FIG. 6 illustrates a close-up view of a portion of an actuation system of the variable vanes of FIG. 2.

FIG. 7a illustrates an alternate high pressure compressor including variable vanes and a dependent variable vane drive system

FIG. 7b illustrates a close-up view of a portion of the dependent variable vane drive system of FIG. 7a.

### DETAILED DESCRIPTION

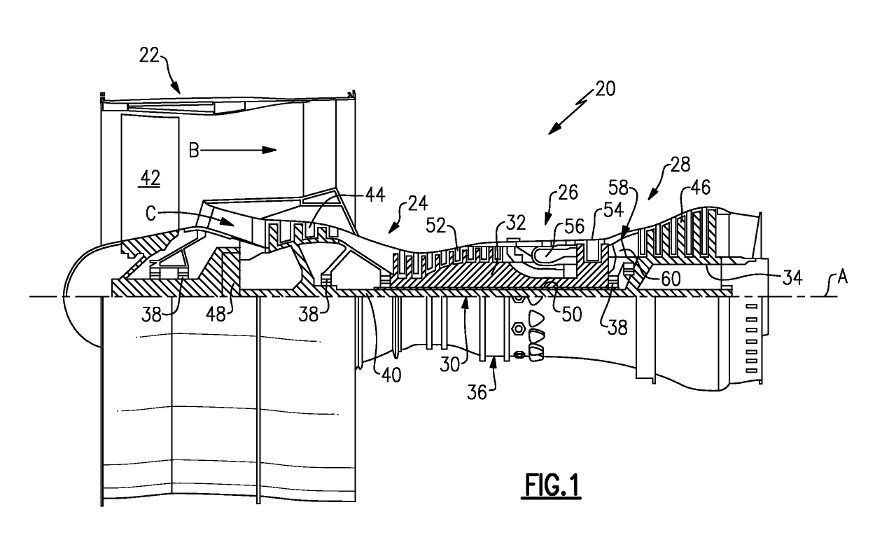

FIG. 1 schematically illustrates an example gas turbine engine 20 that includes a fan section 22, a compressor section 24, a combustor section 26, and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

The core airflow flowpath C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6:1), with an example embodiment being greater than about ten (10:1). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by air in the bypass flowpath B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment, the low fan pressure ratio is less than about 1.45.

“Low corrected fan tip speed” is the actual fan tip speed in ft/sec divided by an industry standard temperature correction of [(Tram° R)/ (518.7° R)] 0.5. The “Low corrected fan tip speed,” as disclosed herein according to one non-limiting embodiment, is less than about 1150 ft/second.

The example gas turbine engine includes the fan 42 that comprises in one non-limiting embodiment less than about twenty-six (26) fan blades. In another non-limiting embodiment, the fan section 22 includes less than about twenty (20) fan blades. Moreover, in one disclosed embodiment the low pressure turbine 46 includes no more than about six (6) turbine rotors schematically indicated at 34. In another non-limiting example embodiment, the low pressure turbine 46 includes about three (3) turbine rotors. A ratio between the number of fan blades and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades in the fan section 22 disclose an example gas turbine engine 20 with increased power transfer efficiency.

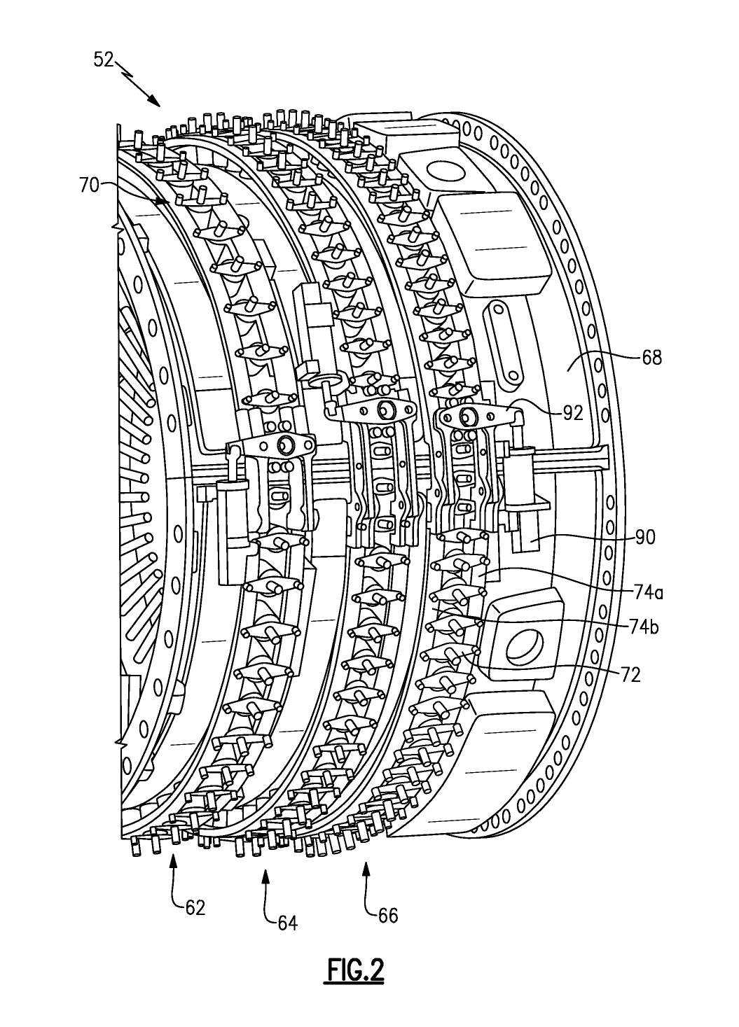

Referring to FIGS. 2-3a with continuing reference to FIG. 1, the high pressure compressor 52 may include one or more stages. In the example shown in FIG. 2, the high pressure compressor 52 includes first, second, and third stages 62, 64, 66, but in another example the high pressure compressor 52 may include a different number of stages. A compressor case 68 may surround portions of the high pressure compressor 52.

The high pressure compressor 52 includes a plurality of variable vanes 70 extending radially relative to the engine axis A. The variable vanes 70 include a vane arm 72 including a first end secured to a first annular sync-ring 74a and an opposing second end secured to a second annular sync-ring 74b. The first and second sync-rings 74a, 74b are movable. In the example shown in FIG. 2, the first sync-ring 74a is arranged downstream from the second sync-ring 74b with respect to the direction of flow through the high pressure compressor 52. A vane stem 75 is secured to the vane arm 72 by a fastener 77. The vane stem 75 is connected to a vane trunnion 76, which is in turn connected to a vane airfoil (not shown). In one example, the vane arm 72 may be secured to the sync-rings 74a, 74b by bolts 78, such as eddie bolts.

In operation, the sync-rings 74a, 74b rotate circumferentially about the engine axis A (FIG. 2) in opposite directions to provide circumferential forces to the first and second ends of the vane arm 72, respectively. Applying these forces causes the vane arm 72 to pivot about a radially extending axis D.

The vane arm 72 may pivot about the location in which it receives the vane stem 75. In the example shown, the circumferential forces applied to the vane arm 72 by the sync-rings 74a, 74b are equal and opposite, but in another example, the circumferential forces applied by the sync-rings 74a, 74b may be unequal. Movement of the first and second sync-rings 74a, 74b moves the vane arms 72, thereby actuating the variable vanes 70. The forces applied to the vane arm 72 by the sync-rings 74a, 74b cause the vane stem 75, the vane trunnion 76 and the vane airfoil (not shown) to rotate about a radially extending axis D.

The load necessary to rotate the vane arm 72 is split between the two sync-rings 74a, 74b, which provides for relatively even loading on the vane arm 72. This may reduce component wear to the vane arm 72, improve concentricity of the sync-rings 74a, 74b with respect to the high pressure compressor 52 and engine 20, and generally reduce the likelihood of the variable vanes 70 becoming out of sync with one another.

The sync-rings 74a, 74b may include load relief slots 80 which serve to relieve any resistive forces, such as axial forces, that are generated when the vane arms 72 are forced to pivot. FIG. 3b shows a detail view of the load relief slot 80 in the sync-ring 74a. In another example, the sync-ring 74b may also include a load relief slot. The load relief slot 80 may be formed around a hole 84 which receives the bolt 78 for securing the vane arm 72 to the sync-rings 74a, 74b. The load relief slot 80 relieves the resistive forces by permitting some axial movement of bolt 78 when the sync-rings 74a, 74b rotate. Relief of these resistive forces prevents the sync-rings 74a, 74b from coming out of alignment with one another and with the high pressure compressor 52, and prevents elastic deflection of the sync-rings 74a, 74b.

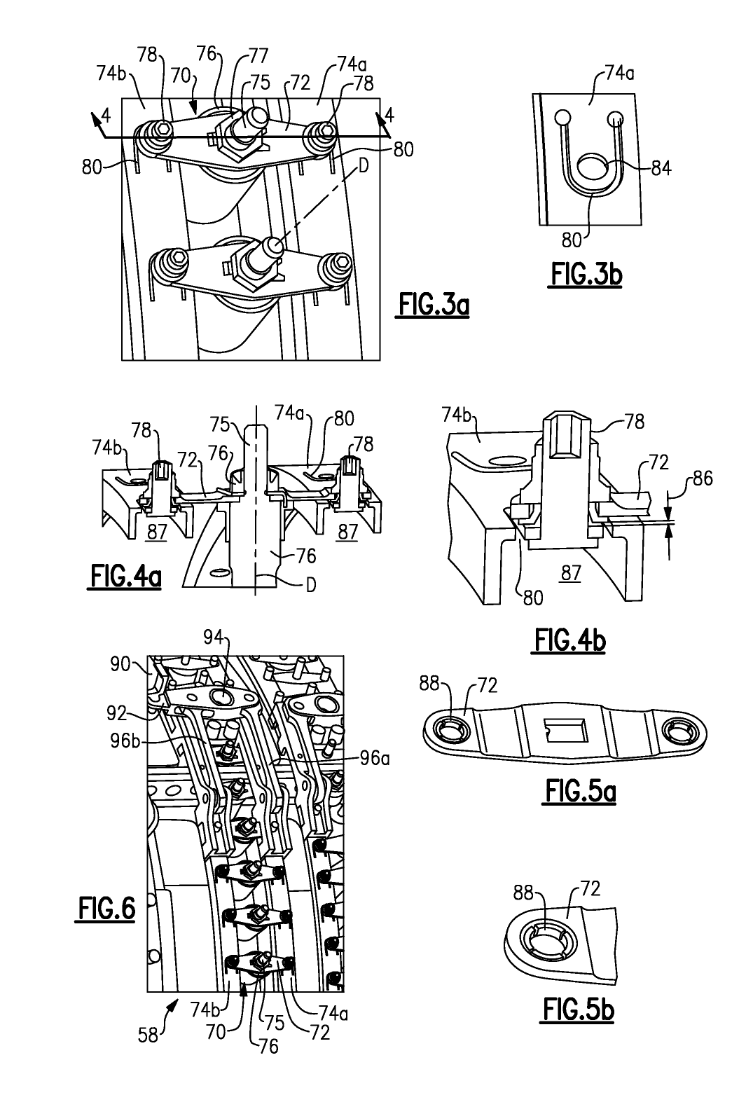

Referring now to FIGS. 4a-5b, the vane arm 72 includes a bushing 88 which receives the bolt 78. A controlled clearance gap 86 is maintained between the bushing 88 and the sync-rings 74a, 74b.The clearance gap 86 provides further axial load relief during variable vane 70 actuation and prevents component wear by allowing for deflection of the vane arm 72 with respect to the sync-rings 74a, 74b. In one example, a channel 87 in the sync-rings 74a, 74b is U-shaped.

Referring again to FIG. 2, the high pressure compressor 52 is shown with an independent drive system. That is, variable vanes 70 in each stage 62, 64, 66 may be actuated independently from one another. In this example, actuators 90 apply a load to bell cranks 92. The bell cranks 92 span both sync rings 74a, 74b in each stage 62, 64, 66. Referring to FIG. 6, the actuator 90 may apply a circumferential load to the bell crank 92 such that the bell crank 92 pivots about a central point 94. The pivoting of the bell crank 92 causes arms 96a, 96b to rotate one of the sync-rings 74a, 74b in a clockwise direction and the other of the sync-rings 74a, 74b in the counterclockwise direction. The sync-rings 74a, 74b thus apply forces to the vane arms 72 to cause the vane arms 72 to pivot about the radially extending axis D (FIGS. 3a and 4a).

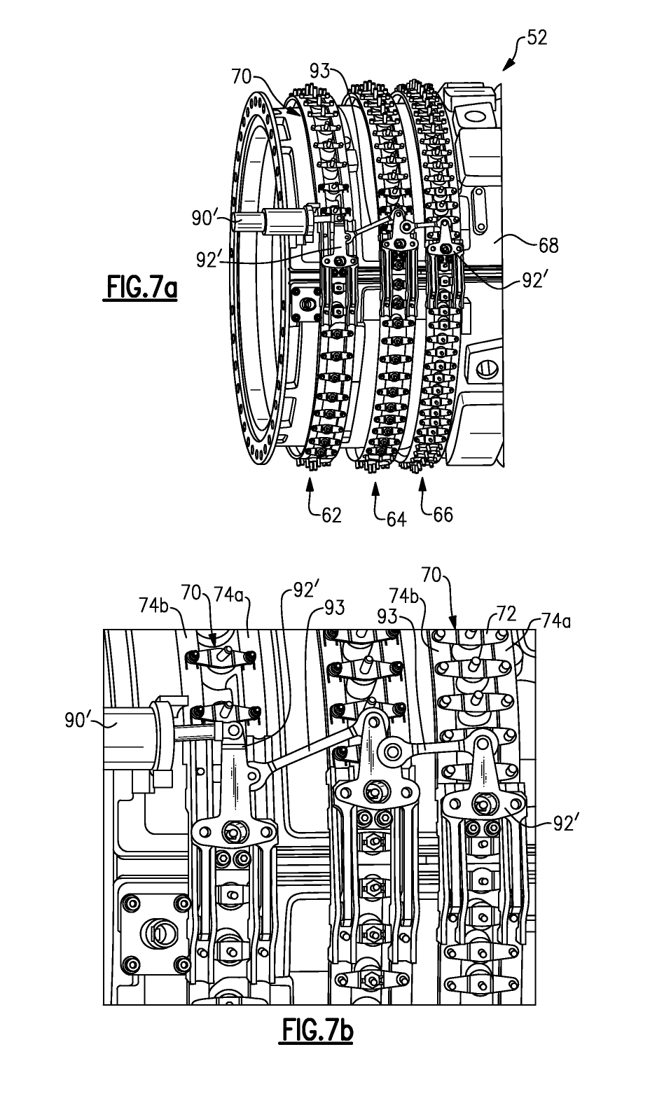

FIGS. 7a-7b show another example of the high pressure compressor 52 with a dependent drive system. In the dependent drive system, the variable vanes 70 in each stage 62, 64, 66 may be actuated in unison. An actuator 90′ applies an axial load to the bell cranks 92′. Links 93 interconnect bell cranks 92′. Axial loads applied by the actuator 90′ are transferred to each bell crank 92′ by a link 93, actuating the variable vanes 70 as was described above. It should be understood that the high pressure compressor 52 may include an independent drive system, a dependent drive system or, a combination of the two.

While the variable vane actuation system is described herein in the context of the high pressure compressor 52, it should be understood that the variable vane actuation system may be used in other parts of the engine which include variable vanes, for example, the high or low pressure turbines 46, 54.

Although an embodiment of this invention has been disclosed, a worker of ordinary skill in this art would recognize that certain modifications would come within the scope of this invention. For that reason, the following claims should be studied to determine the true scope and content of this invention.

1. A section of a gas turbine engine comprising:
a plurality of variable vanes circumferentially disposed about an engine axis;
a first moveable annular ring disposed on an upstream side of the variable vanes;
a second movable annular ring disposed on a downstream side of the variable vanes,
a plurality of vane arms, each including a first end secured to the first annular ring and a second end secured to the second annular ring; and
wherein movement of the first and second annular rings moves the vane arms, thereby actuating the plurality of variable vanes.

2. The engine section of claim 1, wherein movement of the first and second rings causes the vane arm to pivot about a radially extending axis.

3. The engine section of claim 1, further comprising a bell crank configured to move at least one of the first and second rings.

4. The engine section of claim 3, wherein the bell crank is configured to move the first and second rings in opposite circumferential directions.

5. The engine section of claim 3, further comprising an actuator configured to actuate the first bell crank.

6. The engine section of claim 5, further comprising a second engine section including a second plurality of variable vanes circumferentially disposed about the engine axis, a third moveable annular ring disposed on an upstream side of the second plurality of variable vanes, a fourth movable annular ring disposed on a downstream side of the second plurality of vane arms, a second plurality of vane arms, each including a first end secured to the first annular ring and a second end secured to the second annular ring; and wherein movement of the first and second annular rings moves the second plurality of vane arms, thereby actuating the second plurality of variable vanes.

7. The engine section of claim 6, further comprising a second bell crank configured to move at least one of the third and fourth rings.

8. The engine section of claim 7, further comprising a second actuator configured to actuate the second bell crank.

9. The engine section of claim 8, wherein the first and second actuators are configured to operate independently of one another.

10. The engine section of claim 7, further comprising a link configured to transfer forces between the first and second bell cranks.

11. The engine section of claim 10, wherein the actuator is configured to actuate both the first and second bell cranks.

12. The engine section of claim 1, wherein at least one of the first and second rings include at least one load relief slot.

13. The engine section of claim 12, wherein the at least one load relief slot is formed around a portion of one of the first and second rings configured to receive the vane arms.

14. The engine section of claim 1, wherein the engine section is a compressor section.

15. A variable vane assembly comprising:
a vane arm including a portion that engages a variable vane, a first end configured to be secured to a first movable annular ring, and a second end configured to be secured to a second movable annular ring; and
wherein movement of the first and second annular rings moves the vane arms, thereby actuating the plurality of variable vanes.

16. The variable vane assembly of claim 15, wherein the first end is upstream from the second end, relative to a direction of flow through the variable vane assembly.

17. The variable vane assembly of claim 15, wherein the portion that engages the variable vane is between the first and second ends.

18. A method of actuating a variable vane assembly comprising the steps of:
securing a variable vane to a vane arm, the vane arm secured to a first movable annular ring at a first end and a second movable annular ring at a second end; and
moving at least one of the first and second rings to move the vane arm.

19. The method of claim 18, wherein the moving step is provided by a bell crank.

20. The method of claim 19, wherein the bell crank is actuated by an actuator.
